(19) United States
(12) Patent Application Publication
(10) Pub. No.: US 2014/0164956 A1
(43) Pub. Date: Jun. 12, 2014

(54) Social Network Visualization Methods

(71) Applicant: Perceptive Software Research and Development B.V., Apeldoorn (NL)

(72) Inventors: Gueorgui Ivanov Jojgov, Eindhoven (NL); Petrus Cornelis Wilhelmus van den Brand, 's-Hertogenbosch (NL)

(73) Assignee: Perceptive Software Research and Development B.V., Apeldoorn (NL)

(21) Appl. No.: 13/894,851

(22) Filed: May 15, 2013

Related U.S. Application Data
(60) Provisional application No. 61/647,481, filed on May 15, 2012.

(51) Int. Cl. G06F 3/0484

(52) U.S. Cl. CPC G06F 3/0484
USPC 715/753

(57) ABSTRACT

A method of comparing at least two social network models to determine differences and similarities in the at least two social network models. Differences in the actors and the transitions of the at least two social network models are identified and are visually represented in a user interface. The differences in the actors and the transitions of the at least two social network models are indicated in a first format different from a second format that indicates the similarities in the actors and the transitions of the at least two social network models.

### CROSS REFERENCES TO RELATED APPLICATIONS

The present application is related to and claims priority under 35 U.S.C. 119(e) from U.S. provisional application No. 61/647,481, filed May 15, 2012, entitled, “Social Network Model Visualization,” the content of which is hereby incorporated by reference herein in its entirety. The present application also relates to U.S. non-provisional patent application entitled, “Process Model Visualization Methods” which was filed contemporaneously herewith.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to process modeling, and more particularly to social network visualization.

2. Description of the Related Art

Businesses often record or store data or information, such as in a data log, relating to business or workflow processes implemented in a system and the one or more users that are involved in these processes. This type of data may be highly valuable to a company desiring to better understand the workflows involved in accomplishing a particular process goal by providing insight on how existing processes are being implemented by users of the system, as well as, how users that are involved in the execution of the processes are utilized. This data may also help a company in determining how its current workforce is managed in terms of workloads or their interactions with each other. This may potentially help in identifying bottlenecks that need improvement or identifying areas that affect the efficiency of the personnel that are involved in the process.

In order to help businesses better understand their business or workflow processes more effectively, the social structure corresponding to the interaction of one or more actors of a process may be automatically modeled using actual process data. Additional insight on the efficiencies and effectiveness of a social structure may be gleaned if at least two social network models can be compared. For example, such comparisons may be used to more readily identify similarities and distinguish differences between two social network models. They may also more readily demonstrate the effects of a modification on a process or validate whether actors of a process are working as intended. This comparison may be between a social structure model and a social network model generated from actual process data. It may also be a comparison of the social network models using data from two different periods of time. The comparison may also be between an original social network model and a modified version of such model.

### SUMMARY

Methods of social network model visualization are disclosed herein. Comparisons may be made using model data and/or actual usage data. In one example embodiment, the comparison may be between a social network model and a model generated from an actual process data. In an example embodiment, the comparison may be between multiple social network models. In yet another example embodiment, the comparison may of a single social network model using data from two different periods of time. In still another embodiment, the comparison may also be between a social network model and a modified version of such model.

According to one example embodiment, the method of comparing social network models generated from a process comprises comparing the actors and the transitions of at least two social network models, identifying similarities and differences in the actors and the transitions of the at least two social network models, and visually representing the at least two social network models in a user interface, wherein the differences in the actors and the transitions of the at least two social network models are indicated in a first format that is different from a second format that indicates the similarities in the transitions and the actors of the at least two social network models.

According to one aspect of the embodiment, the method may include mining a data set to generate at least one of the at least two social network models. In another aspect, the identifying the similarities in the at least two social network models may include identifying labels common to the actor of the at least two social network models. In yet another aspect, the first format may be a first color or line type and the second format, a second color or line type.

### BRIEF DESCRIPTION OF THE DRAWINGS

The above-mentioned and other features and advantages of the disclosed embodiments, and the manner of attaining them, will become more apparent and will be better understood by reference to the following description of the disclosed embodiments in conjunction with the accompanying drawings.

FIG. 1 is one example embodiment for social network model visualization.

FIGS. 2 and 3 are example variations of an example purchasing procedure process model or workflow and are utilized for illustrative purposes in the creation of social network models.

FIGS. 4 and 5 may be example variations of a social network model that show interactions of the actors involved in the process models illustrated in FIGS. 2 and 3, respectively.

FIG. 6 is one example combined social network model visualization of the example social network models of FIGS. 4 and 5, with the example social network model of FIG. 4 as the reference model.

FIG. 7 is a second example combined process model visualization of the example processes of FIGS. 2 and 3, with the example social network model of FIG. 5 as the reference model.

FIG. 8 shows an example embodiment of the combined social network model of FIG. 6 providing indicators for each of the actors.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms in “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Spatially relative terms such as “top”, “bottom”, “front”, “back”, “rear” and “side” “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

In addition, it should be understood that embodiments of the present disclosure may include both hardware and electronic components or modules that, for purposes of discussion, may be illustrated and described as if the majority of the components were implemented solely in software.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the descriptions below.

These computer program instructions may also be stored in a non-transitory, tangible, computer readable storage medium that may direct a computer or other programmable data processing apparatus to function in a particular manner, such that the instructions stored in the computer readable storage medium may produce an article of manufacture including an instruction means that implements the function specified in the block or blocks. Computer readable storage medium includes, for example, disks, CD-ROMS, Flash ROMS, nonvolatile ROM and RAM. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks. Output of the computer program instructions, such as the process models and the combined process models, as will be described in greater detail below, may be displayed in a user interface or computer display of the computer or other programmable apparatus that implements the functions or the computer program instructions.

A process or workflow may be viewed as a sequence of steps or interactions that are performed to achieve a stated purpose or goal. A step or interaction may itself be a subprocess having its own sequence of steps or interactions. Social network models of a process or workflow may be visually represented by a combination of actors and transitions that show how a process or workflow is executed by one or more actors in a given system.

Social network models may be a social structure that shows the interactions of the one or more actors with the process or with another actor or actors using transitions.

An actor may be a player or a performer in the process such as, for example, a user, a client, or other personnel that are involved in different activities in the process. For example, an actor may represent a user that accesses, performs and/or manages a given activity in the process or workflow. In some aspects, an actor may be a role, a business unit, a department, a team, an area or another group sharing a common function, attribute or goal. An actor label is an identifier that corresponds to the actor in a process model or workflow. An input actor is an actor that causes a process to transition from an event or operation to a subsequent event or operation that may be accessed by that actor or another actor, which may be referred to as an output actor. In alternative example embodiments, the input actor and output actor may be the same player which may occur in cases such as, for example, when two consecutive activities in the process are performed or managed by a single actor.

Transitions in a process model may illustrate the direction or movement between an input actor and an output actor. The input actor of a transition may correspond to an actor that leads the input actor to the output actor. The output actor of a transition may correspond to another actor that performs, accesses or manages an activity that occurs after the activity performed, accessed or managed by the input actor of the transition.

In some example embodiments, social network models may be created manually by a user. For example, a user may illustrate a social network model by hand or using graphics software. A social network model may then be printed or stored electronically for future use. In other example embodiments, social network models also may be automatically generated from data sets of usage, such as an event log, using conventional or proprietary social network mining techniques. As will be understood by those of ordinary skill in the art, social network mining is the method for extracting social network models from data sets, and conventional process mining techniques include alpha, genetic mining, heuristic and fuzzy mining algorithms.

Data sets may include data entries wherein each entry has a case identification, time stamp and actor information. A case identifier may refer to a recorded indicator, such as a number, that identifies which activities are associated with a particular process instance. For example, a case identifier may uniquely identify the object, subset or item going through a state. A time stamp may refer to a date and/or time at which the state indicated by the case identifier occurred. Actor information may be a description of the actor and may represent, for example, an activity, transaction type, physical location or name identifier.

In yet other example embodiments, social network models may be generated by a combination of manual techniques and automatic process mining techniques.

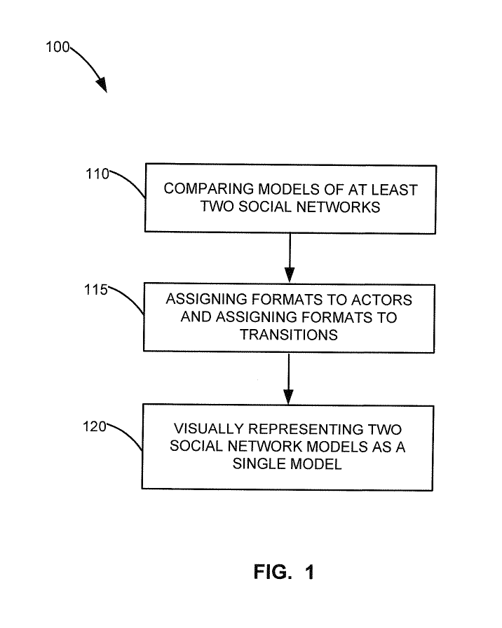

FIG. 1 illustrates one example embodiment for social network models visualization. The method for social network visualization may include at block 110 comparing at least two social network models, assigning, at block 115 formats to actors and assigning formats to transitions and at block 120 visually representing two social network models as a single model. The least two social network models compared may be received by the application from a user.

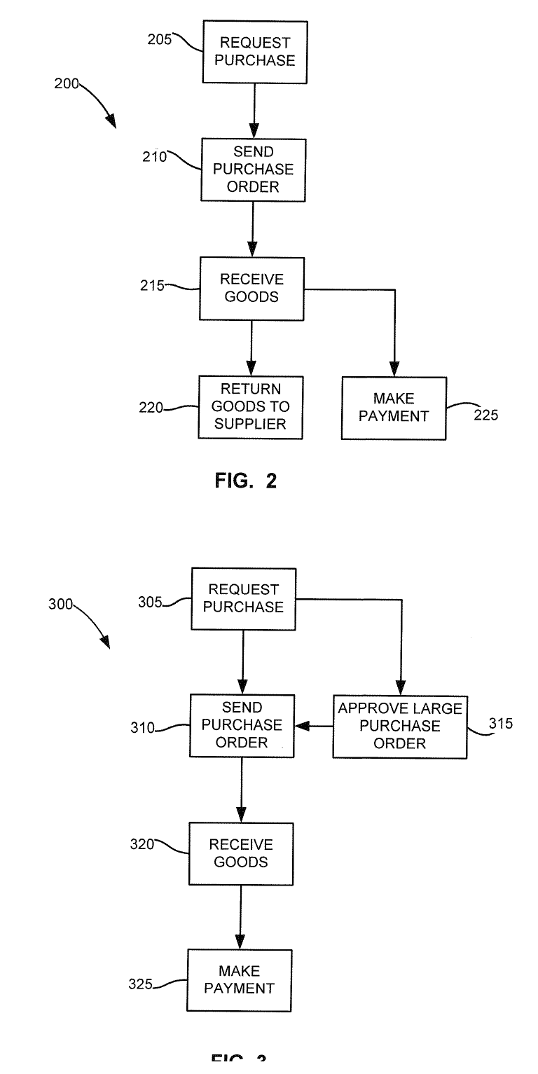

FIGS. 2 and 3 are example variations of a non-limiting simplified purchasing procedure process model and are utilized for illustrative purposes in the creation of social network models. In FIG. 2, at block 205, a purchase is requested. At block 210, a purchase order is sent. At bock 215, the purchased goods are received and then one of two actions ensue. At block 220, the purchased goods are returned to the Supplier, or, alternatively, at block 225 payment is made to the Supplier. In FIG. 3, at block 305, a purchase is requested and then one of two actions ensue. At block 310, a purchase order is sent to the Supplier, or, alternately, at block 315, when a large purchase order is involved, approval of the large purchase order is needed prior to the purchase order being sent at block 310. Thereafter, at block 320, the purchased goods are received, and, at block 325, payment is made to the Supplier.

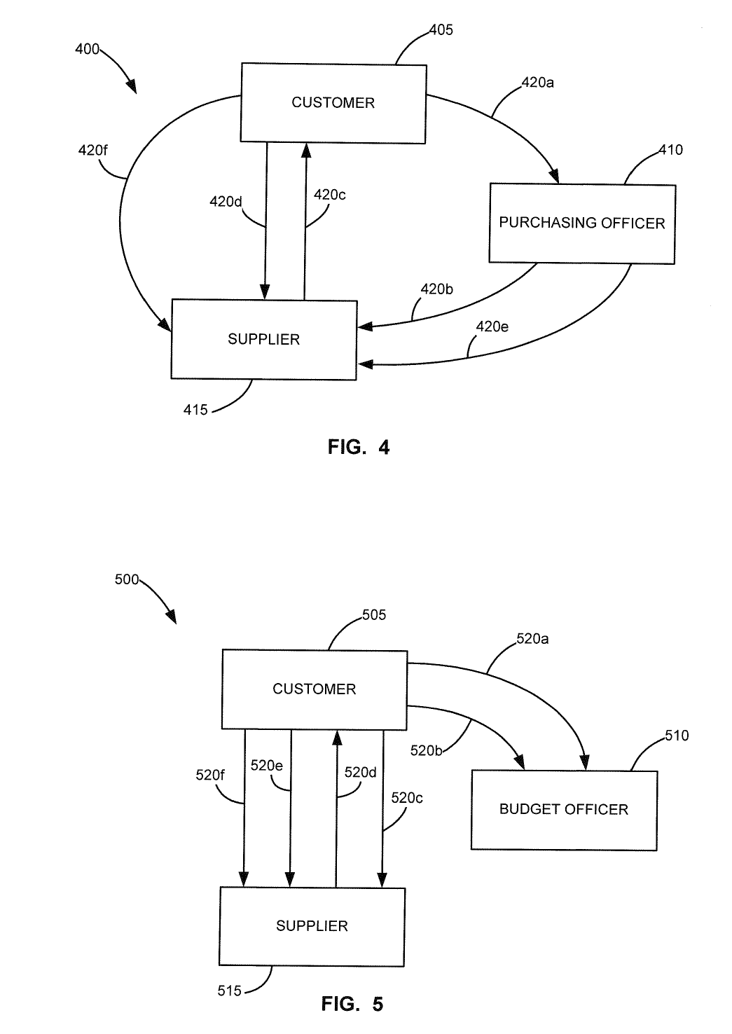

FIGS. 4 and 5 are example variations of a social network model that show interactions of actors involved in the process models illustrated in FIGS. 2 and 3, respectively. FIGS. 4 and 5 are merely utilized to illustrate process model visualization in one example embodiment. Both process model and social network models, however, are not limited to purchasing procedure process modeling. Rather, process model and social model visualization is applicable to any workflow or process used in any business or industry.

The social network model shown in FIG. 4 is one possible social network model created corresponding to the interactions of actors that may be involved in the process in FIG. 2, and the social network model shown in FIG. 5 is one possible social network model created corresponding to the interactions of actors involved in the process in FIG. 3.

For example, as shown in FIG. 4, social network model 400 may be a visualized social structure that shows the interaction of actors that are involved in the process illustrated in process model 200 in FIG. 2. Social network model 400 includes actors 405, 410 and 415 which may be indicated by actor labels Customer for actor 405, Purchasing Officer for actor 410 and Supplier for actor 415.

Transitions illustrated in social network model 400 include transitions 420a-420f. Each transition may have at least one input actor and at least one output actor. The input actor may represent an actor in the process that is associated with a state, event or activity that is performed prior to the state, event or activity that is performed by the output actor. For example, Customer 405 may be the input actor of transition 420a that represents the performer that is involved in an activity that precedes the activity that is performed by Purchasing Officer 410, which is shown as the output actor of transition 420a.

In FIG. 4, Customer 405 interacts with Purchasing Officer 410, as indicated by transition 420a. In this interaction, Customer 405 may request Purchasing Officer 410 that certain goods be purchased, corresponding to Request Purchase 205 in FIG. 2. Purchasing Officer 410 then sends a purchase order to Supplier 415 as indicated by the interaction represented in transition 420b corresponding to Send Purchase Order 210. Supplier 415 then sends goods to Customer 405, an interaction that is represented by transition 420c and corresponds to Receive Goods 215. In Receive Goods 215, Customer 215 may have received goods sent by Supplier 415. In transition 420d, Customer 405 may send a receive goods confirmation to Supplier 415. Purchasing Officer 410 may also make payment to Supplier 415, corresponding to Make Payment 225, thus establishing an interaction between the two actors as represented by transition 420e. In cases where Customer 405 returns goods to Supplier 415, transition 420f may be visualized to represent the interaction made between Customer 405 and Supplier 415 that corresponds to Return Goods to Supplier 220 in FIG. 2. The interactions between actors in social network model 400 that correspond to actors in process model 200 are for the purpose of description and should not be regarded as limiting

In another example social network model, shown in FIG. 5, social network model 500 may be a visualized social structure that shows the interaction of actors that are involved in the process as illustrated in process model 300 in FIG. 3. For illustrative purposes, social network 500 may include actors 505, 510 and 515 which may be indicated by actor labels Customer for actor 505, Budget Officer for actor 510 and Supplier for actor 515.

Transitions in social network 500 may be transitions 520a-520f. Similar to social network 400, the transitions may have an input actor and an output actor. The transition between the input actor and the output actor shows an interaction between the two actors, where the input actor is involved in an activity that precedes the activity that is associated with the output actor. For example, Customer 505 may be the input actor of transition 520c which indicates that Customer 505 is involved in an activity that is performed or associated with Supplier 515, which is the output actor of transition 520c. In alternative example embodiments, an actor may be the input actor of one or more transitions, as shown by Customer 505 in FIG. 5.

In FIG. 5, Customer 505 interacts with Budget Officer 510, as indicated by transition 520a. In this interaction, Customer 505 may send a purchase order to Budget Officer 515, corresponding to Request Purchase 305, in FIG. 3. Budget Officer 515 may also receive large purchase orders sent by Customer 505, as indicated by transition 520b—an interaction corresponding to Approve Large Purchase 315 in process model 500. Customer 505 may send a purchase order to Supplier 515 corresponding to Send Purchase Order 310, in FIG. 3, as indicated by transition 520c. In transition 520d, Supplier 515 sends goods to Customer 505 corresponding to Receive Goods 320. Customer 505 may receive goods from Supplier 515 and confirms receipt to Supplier 515 as indicated by transition 520e. Corresponding to Make Payment 325, Customer 505 may send payment to Supplier 515 as indicated by transition 520f. As aforementioned, the interactions between actors in social network model 500 that correspond to actors in process model 300 are for the purpose of description and should not be regarded as limiting

While these example embodiments show social network models as flow chart models, it will be appreciated by those of ordinary skill in the art that other models may be used. Other example models may include, but are not limited to, functional flow diagrams, control flow diagrams, Petri nets or state diagrams.

Referring back to FIG. 1, at block 110, the example social network models 400 and 500 may be compared. Comparing the social network models may include identifying which of the two social network models, each actor and each transition may be present. In an example embodiment, comparing the social network models may include identifying whether an actor or a transition occurs in one social network model but not in the other, or if an actor or a transition occurs in more than one social network model.

Determining whether an actor is present in a particular model may include actor label matching. Actor label matching includes identifying an actor in one social network model and determining whether the actor identified in the one social network model occurs or is present in a second or another social network model. In one example embodiment, actor labels are matched when two or more social network models are determined to contain the same labels. For example, Customer 405 may be identified to occur in social network model 400. Actor label matching may search for an actor in social network model 500 having an actor label Customer which, in the illustrative example embodiment involving FIGS. 4 and 5, corresponds to Customer 505 in social network model 500, thereby identifying that Customer 405 occurs in both social network models 400 and 500.

In another alternative example embodiment, determining whether an actor is In present in a particular model may include utilizing a translation table of actor labels from one model to another. The translation table may include identifying whether an actor in a first social network model matches another actor in a second social network model using similarities in the actor labels of the first actor and the second actor. For example, if a first social network model, referred as a reference model hereinafter, contains an actor having a actor label “Customer”, and the second social network model including another actor having a actor label “Customers”, the translation table may identify that the two actor labels “Customer” and “Customers” refer to the same actor or event and translates one of the two actor labels to the other. Using the two actor labels as an illustrative example, the “Customers” of a second social network model may be changed or translated to “Customer” to match the actor label in the reference model. In one alternative aspect, the translation table may associate the two states without changing the state labels in the process models. In an alternative example embodiment, the matching of the actor labels of the two social network models may be performed prior to comparison.

Determining whether a transition is present in the social network models may include identifying the input actor and the output actor of a transition. If the input and output actors are the same for a transition in the at least two compared social network models, then the transition is determined to be present in both or in multiple social network models, when more than two social network models are compared. For example, social network model 400 may be checked to identify transitions that are present in both social network models. In social network model 400, transition 420e is determined to have the input actor having actor label “Supplier”, and output actor having actor label “Customer”. In social network model 500, transition 520d is identified to have an input actor having label “Supplier” and an output actor having actor label “Customer”. Thus, transition 420c is determined to be present in both social network models 400 and 500 and there is a transition match between transition 420c and transition 520d.

On the other hand, a transition in one social network model may be determined to be present in a particular social network model but not in the reference model or, alternately, present in the reference model but not in the particular social network model, the transition fails to match. For example, with social network model 400 being the reference model, transition 420a may be checked to see if it is present in other social network models, e.g. social network model 500. Transition 420a includes an input actor 405 having label “Customer”, and an output actor 410 having label “Purchasing Officer”. Determining if transition 420a is present in social network model 500 may include finding an input actor having a matching (or at least associated) label as that of the input actor Customer of transition 420a. In social network model 500, transition 520a contains an input actor 505 having label “Customer”, which matches the input actor of transition 420a. However, the output actor of transition 520a is Budget Officer 510, which is different from the output actor Purchasing Officer of transition 420a. Purchasing Officer 410 is identified to be the output actor to another actor apart from input actor Customer 405 through transition 420a. Because both the input actor and the output actor are not the same for transition 420a of social network model 400 and transition 520a of social network 500, transition 420a in social network model 400 is determined to be present in the example reference social network model 400 but not in social network model 500.

As will be appreciated by those of ordinary skill in the art, transition matching may involve the use of an actor label translation table in some example embodiments. For example, if a transition in a first social network model has an input actor with a actor label “Customer” and an output actor has a actor label “Purchasing Officer” and a transition in a second or another social network model has an input actor with a actor label “Customer” and an output actor has a actor label “Purchasing Manager”, a translation table may be used to verify or confirm whether the two output actor labels “Purchasing Officer” and “Purchasing Manager” refer to the same actor. If there is a translation or association between the actor labels of the different social network models, the transition is identified as being the same transition.

In some alternative example embodiments, the comparison of social network models may involve determining whether each actor and each transition from each model belong to a subset of models. For example, if actor A occurs in each of three social network models X, Y, and Z, then the subset of actor A is {X,Y,Z}.

For example, actors 405 and 505 may be determined to be identical actors and are present in both social network models 400 and 500. Thus, the subset for actors 405 and 505 is {social network model 400, social network model 500}. In another example, actor 410 is determined to occur in social network model 400 but not in social network model 500. Thus, the subset for actor 410 would be {social network model 400}.

For illustrative purposes, the actors and transitions of the process models shown in FIGS. 4 and 5 having the subset of models {social network model 400, social network model 500} includes: Customer 405 and 505, Supplier 415 and 515 and transitions 420e, 420d, 520c, 520d.

The actors and transitions determined to have a subset of models {social network model 400} include: Purchasing Officer 410 and transitions 420a, 420b, 420e.

The actors and transitions determined to have a subset of models {social network model 500} include: Budget Officer 510, and transitions 520a, 520b, 520e, 520f.

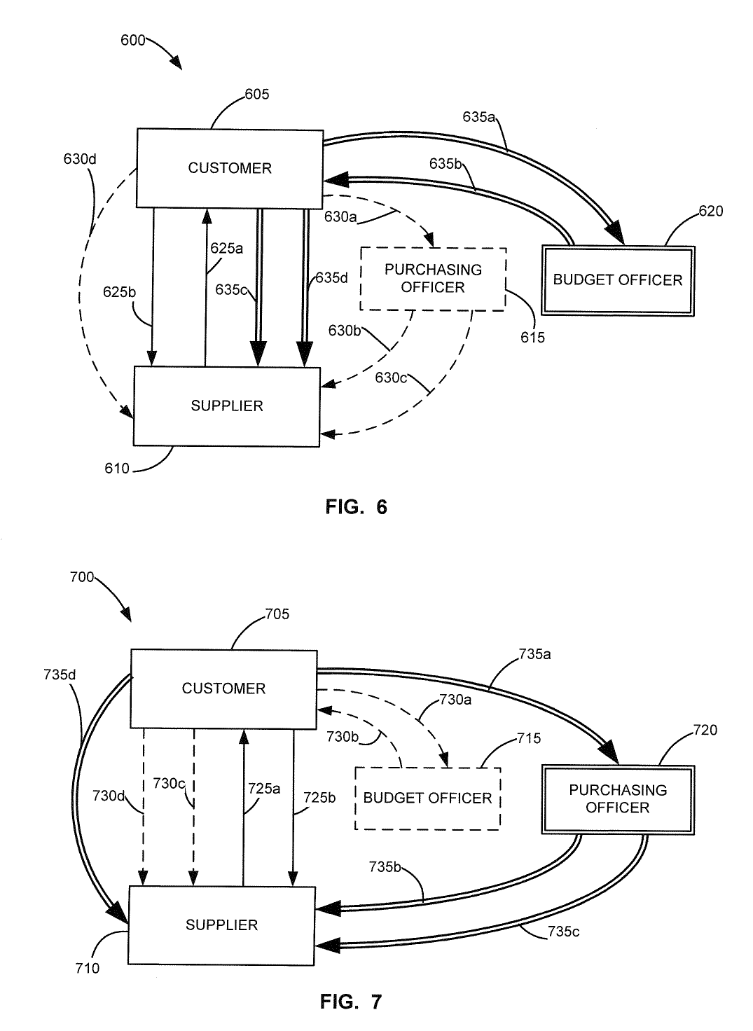

Returning to FIG. 1, formats may be assigned to each actor and transition at block 115. The format assigned to each actor and each transition may be based on the differences between and similarities of the at least two social network models. For example, if social network model 400 is determined to have an actor or a transition that occurs in social network model 400 but does not occur in social network model 500, each of these actors and transition may be assigned a broken line pattern as illustrated in FIGS. 6-7. For actors and transitions that occur in social network model 500 but do not occur in social network model 400, a double line format may be used and a different format may be assigned to the actors and transitions which occur in both or all of the process models being compared, as illustrated in FIGS. 6-7. For example, the actors and transitions that occur in both social network models 200 and 300 may be assigned a single line format to indicate that the actors and transitions are similar or occur in each of the social network models, again, as illustrated in FIGS. 6-7.

In another aspect, formats may be assigned to each subset. Formats may be line types, colors, patterns or any other format capable of visually distinguishing between similar and differing actors and/or transitions. For example, subset {social network model 400, social network model 500} may be assigned a single line pattern, subset {social network model 400} may be assigned a broken line pattern, and subset {social network model 500} may be assigned a double line pattern.

Each actor and transition may be assigned the format corresponding to the format assigned to the subset. For example, the actors and transitions having the subset {social network model 400, social network model 500} which include Customer 405 and 505, Supplier 415 and 515 and transitions 420c, 420d and 520c, 520d may be assigned the single line format. The actors and transitions having the subset {social network model 400} which include Purchasing Officer 410 and transitions 420a, 420b and 420e may be assigned the broken line format. The actors and transitions having the subset of models {social network model 500} which include Budget Officer 510, transitions 520a, 520b, 520; 520f may be assigned the double line format.

At block 120, each actor and transition may be combined into one social network model and displayed using the assigned format, as shown in FIGS. 6 and 7.

In some example embodiments, one social network model may be automatically selected by the application as the reference model. In other example embodiments, the user may select the process model to be used as the reference model. The layout of the reference model may then be used as a starting point for the display of the combined model on a user interface. Thus, in the combined model, the actors and transitions of the reference model may be positioned or located in the same positions as they are laid out in the original reference model. Any actors and transitions appearing in another model but not in the reference model may be positioned using conventional model layout techniques, as will be described in greater detail below.

FIG. 6 shows one example combined social network model 600 of social network models 400 and 500 with social network model 400 as the reference model. For illustrative purposes, in combined social network model 600, the two social network models 400 and 500 are combined in a single model with indicators showing the subsets of each of the actor and the transition of both social network models 400 and 500. The layout of social network model 400, the reference model in this example, may be the foundation for the layout of combined social network model 600 with the actors and transitions of social network model 400 being positioned or located in similar positions on the user interface or display as they are laid out in the original social network model 400 of FIG. 4, and the actors and transitions occurring in social network model 500 but not in reference social network model 400 being positioned using various model layout techniques. Actors and transitions occurring in both social network models 400 and 500 are indicated by a single line; actors and transitions occurring only in social network model 400 are indicated by a dashed line; and states and transitions occurring only in social network model 500 are indicated by a double line.

For example, Customer 405 and 505 are determined to occur in both social network models 400 and 500 and therefore, have a subset of {social network model 400, social network model 500}, with an assigned format of a single line. In combined social network model 600, Customer 405 and 505 are represented as Customer 605 formatted with single line. Other actors and transitions that occur in both social network models 400 and 500 and are indicated with the single line format include Supplier 610, corresponding to Supplier 415 and Supplier 51.5; and transitions 625a corresponding to transitions 420c, 520d, respectively, and transition 625b corresponding to transitions 420d, 520e, respectively.

In combined social network model 600, actors and transitions which occur only in social network model 400, the reference model, are indicated by a dashed line format. These actors and transitions include Purchasing Officer 615, corresponding to Purchasing Officer 410 and; transitions 630a, 630b, 630c, 630d corresponding to transitions 420a, 420b, 420e, 420f, respectively.

In combined social network model 600, actors and transitions which occur only in social network model 500 and therefore having the subset {social network model 500} are indicated by a double line format. The actor and transitions include Budget Officer 620 corresponding to Budget Officer 510; and transitions 635a, 635b, corresponding to transitions 520a, 520b, respectively and transitions 635e, 635d, corresponding to transitions 520e, 520f, respectively.

FIG. 7 shows a second example combined social network model 700 of social network models 400 and 500 with social network model 500 as the reference model. The layout of social network model 500 is illustrated as the foundation for the layout of combined social network model 700, with the states and transitions of social network model 500, the reference model in this example, being positioned or located in similar positions on the user interface as they are laid out in the original social network model 500 of FIG. 5, and the states and transitions occurring in social network model 400 but not in the reference social network model 500 being positioned using various model layout techniques. States and transitions occurring in both social network models 400 and 500 are indicated by a single line; states and transitions occurring only in social network model 400 are indicated by a double line; and states and transitions occurring only in social network model 500 are indicated by a dashed line.

For example, the actors and transitions having the subset {social network model 400, social network model 500} may be assigned the single line format to indicate that the actors and transitions have the same subsets and/or that they occur to both social network models 200 and 300. The matching or common states and transitions of social network models 400 and 500 are shown in combined social network model 700 include Customer 405 and 505, represented as Customer 705 and formatted with a single line. Other actors and transitions that are common in social network models 400 and 500 and are indicated with the single line format include Supplier 710, corresponding to Supplier 415 and Supplier 515; transition 725a corresponding to transitions 420c, 520d, respectively; and transition 725b corresponding to transitions 420d and 520c, respectively.

In combined social network model 700, actors and transitions which occur only in social network model 400 and therefore having the subset {social network model 400} are indicated by a double line format. These actors and transitions include Purchasing Officer 720, corresponding to Purchasing Officer 410 and; transitions 735a, 735b, 735c, 735d corresponding to transitions 420a, 420b, 420e, 420f, respectively.

In combined social network model 700, actors and transitions which occur only in social network model 500, the reference model, are indicated by a broken line format. The actor and transitions include Budget Officer 715 corresponding to Budget Officer 510; and transitions 730a, 730b, 730c, 730d corresponding to transitions 520a, 520b, 520e, 520f respectively.

In some alternative example embodiments, actors and transitions appearing in one model but not in the reference model may be placed in a default location in the user interface or display, such as in one of the corners. In one aspect of this example embodiment, actors and transition occurring in one model but not in the reference model may be positioned to the side of the reference model structure.

In one example embodiment, additional information regarding the social network models and the data set which they represent may be added. Such additional information may include, but is not limited to, performance information such as, for example, waiting times, length of interaction between two or more actors, number of times a particular actor performs, accesses or manages an activity, among many others.

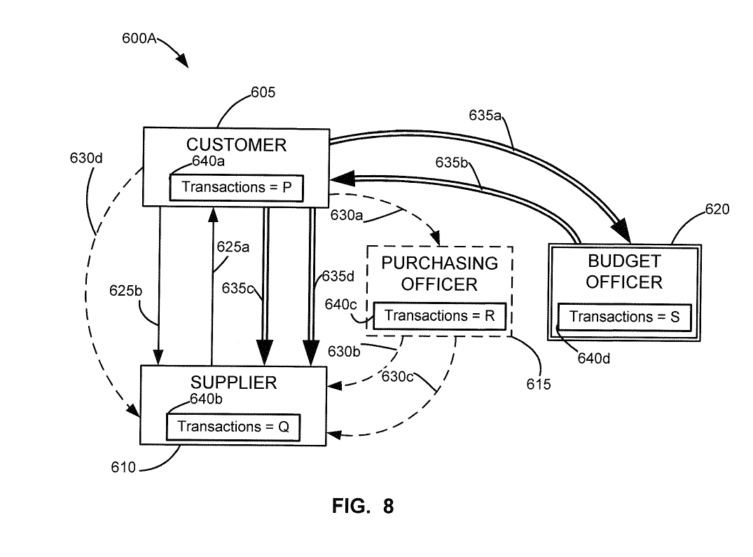

FIG. 8 illustrates an alternative example of combined social network 600 of social network models 400 and 500 with the process model 400 as the reference process model, in accordance with another aspect of the present disclosure. Elements of combined social network 600A that are the same or similar to those in combined social network 600, will carry the same or similar reference numerals.

In an alternative example embodiment, combined social network 600A may include indicators that may represent one or more information about an actor or a transition. For example, an indicator may be used to display the number of cases that is performed by a given actor or a number of cases that transition from one actor to another. In some example embodiments, the displayed indicators may also represent performance metrics, such as processing times for cases or waiting times for actors. It will be apparent by one of ordinary skill in the art that information other than those aforementioned may be represented by the indicator and that not all actors or transitions in combined social network model 600 may include an indicator. In one example embodiment, individual social network models that are not compared or combined may also include indicators.

For example, indicators 640a, 640b, 640c, 640d may display the number of transactions that associated with actors Customer 605, Supplier 610, Purchasing Officer 615, and Budget Officer 620, respectively. Indicator 640a shows that the number of transactions for Customer 605 is P. Indicator 640b shows that the number of transactions for Supplier 610 is Q. Indicator 640c shows that the number of transactions for Purchasing Officer 615 is R. Indicator 640d shows that the number of transactions for Budget Officer 620 is S.

In another aspect of this example embodiment, combined social network model 600A may display indicators referring to delta between performance measures of the reference model and the other social network models that are compared to the reference model may be calculated. The performance measures of each of the social network models may refer to one or more measurements that denote how the process represented by the social network model is performed. The performance measures, for example, may refer to the amount of time an actor of a particular social network model performs an activity or the amount of time it takes for an actor to transition from one actor to another. Other data, such as the number of users that access a given actor for a particular social network model, may also be used as a performance measure that is compared between the reference model and at least another social network model. It will be apparent to one of ordinary skill in the art that other performance measures may be used in conjunction with this embodiment.

A delta may be a calculated difference between the at least two performance measurements of the reference social network model and the other social network models compared to the reference model. In another alternative example embodiment, actors that are not involved in the process associated with the reference model but occur in another social network model that is compared to the reference model may be displayed as separate social network models with indicators showing differences. Indicators may include formatting such as, for example, color, line type, patterns, and many others as will be known by one of ordinary skill in the art.

It will be appreciated that the actions described and shown in the example flowcharts may be carried out or performed in any suitable order. It will also be appreciated that not all of the actions described in FIG. 1 need to be performed in accordance with the embodiments of the disclosure and/or additional actions may be performed in accordance with other embodiments of the disclosure.

While the example embodiments are illustrated using two social network models, it will be appreciated by those of ordinary skill in the art that more than two social network models may be compared or that one social network model over different time periods may be compared. It will also be appreciated by those of ordinary skill in the art that the example embodiments for social network model visualization are applicable to any workflow or process used in any business or industry and are not limited to a particular business process, entity type or industry.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of comparing social network models generated from a process, comprising:
comparing actors and transitions of at least two social network models;
identifying similarities and differences in the actors and the transitions of the at least two social network models; and
visually representing the at least two social network models in a user interface,
wherein the differences in the actors and the transitions of the at least two social network models are indicated in a first format that is different from a second format that indicates the similarities in the transitions and the actors of the at least two to social network models.

2. The method of claim 1, further comprising mining a data set to generate at least one of the at least two social network models.

3. The method of claim 1, wherein the identifying the similarities in the at least two social network models includes identifying labels common to the actors of the at least two social network models.

4. The method of claim 1, wherein the first format is a first color and the second format is a second color.

5. The method of claim 1, wherein the first format is a first line type and the second format is a second line type.

6. The method of claim 1, wherein the first format is a first pattern and the second format is a second pattern.

7. The method of claim 1, wherein the visually representing the at least two social network models comprises visually representing the at least two social network models as a single social network model.

8. The method of claim 1 wherein identifying differences in the actors and the transitions of the at least two social network models includes identifying differences between the actors and identifying differences between the transitions.

9. The method of claim 1, wherein the visually representing the at least two social network models includes positioning the actors and the transition occurring in a first social network model in a layout that preserves a structure of the first social network model.

10. The method of claim 1, wherein performance information regarding the at least two social network models is displayed.

11. The method of claim 1, wherein the actors of the at least two social network models correspond to an actor performing states of a process.

12. A method of comparing at least two social network models, the at least two social network models including at least two actors and at least one transition, the method comprising:
comparing the at least two actors and the at least one transition of the at least two social network models;
identifying in which of the at least two social network models each of the at least two actors occur;
identifying in which of the at least two social network models the at least one transition occurs; and
visually representing at least one of the at least two social network models in a user interface,
wherein the actor and the transition of the at least two social network models are indicated in a format corresponding to a subset of the at least two social network models in which the at least two actors and the at least one transition occurs.

13. The method of claim 12 wherein the subset comprises a first subset wherein one of the at least two actors or the at least one transition occurs only in one of the at least two social network models, a second subset wherein one of the at least two actors or the at least one transition occurs only in the other of the at least two social network models and a third subset when one of the at least two actors or the at least one transition occurs in each of the at least two social network models and the first, second and third subsets are visually represented in a user interface with each of the first, second and third subsets having a different format.

14. The method of claim 12, further comprising mining a data set to generate at least one of the at least two social network models.

15. The method of claim 12, wherein the identifying if the transition occurs in the at least two social network models includes determining if an input actor and an output actor of the transition occurring in the one of the at least two social network models is similar to an input actor and an output actor of a transition in the other of the at least two social network models.

16. The method of claim 12 wherein when the input actor and the output actor is the same to for the at least transition in the at least two social network models, the at least one transition occurs in the at least two social network models.

17. The method of claim 12, wherein the identifying the social network models in which the actors occur includes matching an actor label in one of the at least two social network models with an actor label in the other of the at least two social network models.

18. The method of claim 12, wherein the format corresponding to the subset of the at least two social network models in which the actor occurs is indicated by a first color.

19. The method of claim 12, wherein the format corresponding to the subset of the at least social network models in which the transition occurs is indicated by a first line type.

20. The method of claim 12, wherein the visually representing the at least two social network models includes visually representing the at least two social network models as a single social network model containing a plurality of formats indicating the subsets of the at least two social network models in which the actor and the transition occurs.

21. A non-transitory, tangible computer readable storage medium containing executable instructions for performing a method comprising:
comparing actors and transitions of at least two social network models;
identifying similarities and differences in the actors and the transitions of the at least two social network models; and
visually representing the at least two social network models in a user interface,
wherein the differences in the actors and the transitions of the at least two social network models are indicated in a first format that is different from a second format that indicates similarities in the actors and the transitions of the at least two social network models.
